(19) United States
(12) Patent Application Publication
(10) Pub. No.: US 2016/0298365 A1
(43) Pub. Date: Oct. 13, 2016

(54) CASSETTE RESTRAINTS

(71) Applicant: Isaac Christensen, Ogden, UT (US)

(72) Inventor: Isaac Christensen, Ogden, UT (US)

(21) Appl. No.: 15/091,225

(22) Filed: Apr. 5, 2016

Related U.S. Application Data
(60) Provisional application No. 62/144,290, filed on Apr. 7, 2015.

(51) Int. Cl. E05B 75/00

(52) U.S. Cl. CPC E05B 75/00

(57) ABSTRACT

The present invention relates to prisoner restraint devices. More specifically, the present invention relates to a lightweight handcuff cassette capable of restraining an individual's hands using a selectable cord-like element. For example, paracord may be used with the cassette to restrain an individual's hands. The cassette may be lockable with a single or a double key.

### BACKGROUND

1. State of the Art

The present invention relates to prisoner restraint devices. More specifically, the present invention relates to a lightweight handcuff cassette capable of restraining an individual's hands using a selectable cord-like element. For example, paracord may be used with the cassette to restrain an individual's hands or ankles.

2. Field of Art

Peace-keeping officers, such as police, soldiers, or private security guards, increasingly encounter large groups of people who must be restrained, either for arrest or due to safety concerns. When they anticipate such encounters, peace-keeping officers often carry a large number of handcuffs or cable ties for restraining persons. This is necessary both to prevent escape of those persons while being transported to detention facilities, and to reduce the likelihood of injury to law enforcement personnel after taking an individual into custody.

Traditional handcuffs, however, are prohibitively bulky and expensive for most crowd-control applications. For soldiers, who are often carrying many pounds of additional gear, metal handcuffs are far too heavy and can become extremely hot in direct sun. Heavy handcuffs may be used by a prisoner as a striking weapon against a guard or police officer.

Due to the expense and bulkiness of traditional metal handcuffs, various law enforcement and peacekeeping agencies have sought out replacement devices, which can be used as temporary restraints on persons taken into custody. One such device which has received significant interest is the traditional cable tie. The traditional cable tie includes an elongated strap extending from a ratcheting pawl. The strap can be bent upon itself to form a closed loop upon insertion through the pawl. The strap has teeth running a substantial portion of its length so that the loop formed by the strap maybe reduced in size by continued insertion of the strap through the pawl. The pawl locks against these teeth and prevents withdrawal of the strap or expansion of the dimension of the loop. This loop can be placed around a person's wrists and then tightened, effectively locking the wrists together.

These devices are lightweight. However, they are also subject to many disadvantages. Most cannot be reused, and must be cut off a person's wrists. A cutting tool is likewise a security concern, as it could be used as a weapon or used to cut through fences.

Because most cable tie plastics are UV-sensitive, they are subject to damage from intense sunlight. In order to use a cable tie quickly, it is necessary to feed the tip of the strap through the pawl to form a loop before encountering the person to be restrained—but once a loop is formed, the cable tie can be accidentally tangled with other cable ties. It is possible, especially during stressful situations, to miss-thread the strap through the pawl, so that the teeth do not effectively catch on the pawl, and the person can more easily escape. Cable ties can damage skin if left on a person too long.

Finally, cable tie plastics can be chewed through, or broken by repeated rubbing against an edged surface. The cable tie cannot be replaced, nor can the mechanism be reused. Even the edges of many prior art disposable handcuffs are similar to the sharp edges of traditional handcuffs made of metal. Sharp edges may cut wrists of the detainees and may even cause injury to the officer using the handcuffs.

Some devices employ loops of cable ties or cords, crimped together with a loop connector, as in U.S. Pat. No. 4,964,419 to Karriker. Such handcuffs are re-useable, but because they do not include a key lock, they are not particularly secure. A prisoner can escape merely by locating a surface on which to depress the plunger, opening the crimping mechanism and releasing the handcuff cord loops. In addition, the handcuff cord loops are always exposed, and thus subject to the same problems of sun damage and tangling as typical cable tie handcuffs. In addition, such devices are not particularly flexible for use outside of restraining prisoners. Because the amount of cord is limited, the device cannot be used, for example, to lock luggage or to secure unwieldy loads.

Lengths of nylon or cotton rope may be used as crude handcuffs in non-critical detentions, and can also be used for securing luggage or other purposes. Both types of cordage make good knots, however, both are subject to fraying and damage caused by rubbing against surfaces.

Kernmantle rope such as paracord may be used, as it is more abrasion-resistant. In kernmantle rope, the interior core—the kern—is protected by a woven exterior sheath—the mantle. The core fibers provide the tensile strength of the rope, while the external mantle protects the core from abrasion during use. When nylon fibers are used, kernmantle rope or paracord is both soft and tough. Paracord is also widely available. However, kernmantle rope such as paracord is somewhat elastic, and stretches when repeated strain is placed on it.

With repeated twisting, a prisoner may be able to loosen the handcuffs enough to escape. Further, typing knots in loose lengths of cord requires time rarely available in hazardous situations.

Thus, there is a need for a compact, portable, simple, disposable and reusable, locking system for securing prisoners in such a manner that the prisoner's skin is not damaged, but the prisoner is unlikely to escape. It is advantageous if the restraints can be used for purposes outside of securing a prisoner. It is further advantageous if the locking system can accept paracord, and can be quickly and easily tightened.

### SUMMARY OF THE INVENTION

The following summary of the present invention is not intended to describe each illustrated embodiment or every possible implementation of the invention, but rather to give illustrative examples of application of principles of the invention.

In some embodiments, the locking cassette includes a box having a removeably attached cover plate attached to a base member. The cover plate and base member may be formed, for example, of metal or out of a variety of plastics. Durable plastics such as polyvinyl chloride or polypropylene may be advantageous for their light weight, and resistance to corrosion or water damage. The cover plate may be formed of a different material than the base member. For example, the cover plate may be plastic to facilitate printing instructions thereupon, while the base member may be metal, for greater strength.

Instructions may be printed on the locking cassette, in order to improve use time during stressful situations.

The cover plate may be attached to the base member by a fastener. For example, screws, rivets, clips, bolts, or adhesive may attach the cover plate to the base member. In one embodiment, four or more screws attach the cover plate to the base member. Where plastic is used for the base member, the screw holes may be clad with metal to prevent wear.

The body of the locking cassette may have rounded edges, in order to prevent damage to the user or the restrained person.

The locking cassette also includes at least one keyhole, adapted to accept a standard handcuff key. In some embodiments, a single keyhole serves to operate a pair of rotating locking members, or pawls. For example, when the key is inserted and turned, a pressure bar may be moved out of alignment, allowing the rotating locking members to rotate into a disengaged position. In other embodiments, each rotating locking member or pawl includes a tensioner, so that when the key is inserted, the tension is released and the rotating locking members rotate into a disengaged position. In some embodiments, the tensioner may be spring tension rings.

The rotating locking member or members include a securing edge. In some embodiments, the securing edge may be a fin, a pad with rough texture, a series of jagged protrusions, or any comparable means of securing a cord or cable. When rotated into position, the securing edge engages and secures the handcuff cord. The handcuff cord may be secured, for example, by pinching it between the securing edge and an inner wall of the locking cassette, by frictionally engaging the handcuff cord, or by piercing the handcuff cord.

Some embodiments include a tensioner for keeping the rotating locking member, or pawl, in the correct position unless released with a key. The tensioner may be, for example, deformable metal or plastic, and may be a spring placed around a retaining peg, or other means such as a clip or a pressure bar.

In still other embodiments, the locking cassette includes only one rotating locking member or pawl, operated by a single key.

In some embodiments, the locking cassette includes a cord. The cord may be formed of a variety of materials, such as nylon, cotton, polyester, plastic, steel links, and the like. The rotating locking member may be adapted, depending on the type of cord to be used: for example, a rougher securing edge may be used where the cord is smoother. In a preferred embodiment, a single nylon paracord or kernmantle rope is used for the cord, however the locking cassette can also be adapted to accept a multiple of cords.

One advantage of the present disclosure is that the paracord, if damaged or deformed, may be quickly pulled from the cassette and replaced with a fresh piece of cordage. The top cover of the cassette may be removed and the paracord placed inside, or the paracord may be threaded through the channels and spacer holes. In the latter case, it is advantageous if the channels and spacer holes are throated—having a smooth transition between the channel and the exterior of the cassette—to allow the paracord or other cordage to be more smoothly threaded through the cassette.

In some embodiments, the locking cassette features dual loops adapted to fit around each wrist. A single cord may still form the dual loops. In this case, the cassette additionally comprises one or more spacer openings, through which the cable is threaded, in order to create two loops. The spacer opening may extend through the entire cassette, or may extend only through the cover plate or base member. In other embodiments, the cord forms a single loop for both of a prisoner's wrists.

According to one aspect of the present disclosure, the entire cassette may be disassembled by, for example, unscrewing the cover plate and the base member. For example, four or more screws may secure the cover plate to the base member.

According to another aspect of the present disclosure, one portion of the cord may be secured within the body of the cassette. This may be accomplished, for example, by clamping the cord, by inserting nails or screws therethrough, or by any other means known to one of skill in the art.

In some embodiments, the locking cassette has two channels extending therethrough, for receiving the handcuff cord.

Some embodiments of the locking cassette may be manufactured by forming a box having a removeably attachable cover plate, forming channels in the box for receiving a single length of cord, affixing a rotating locking member, having a keyhole therein, into the box, and threading a cord through the box, such that the cord is in contact with the rotating locking member. The method may further comprise fixing one portion of the cord inside the box with a cord securing mechanism.

In some embodiments, multiple cassettes are strung along the same cord. In this manner, several individuals may be quickly and easily locked together in a line, considerably easing the task of maintaining control over several prisoners.

In one aspect of the present invention, a device such as a set screw is placed to extend into the body of the cassette between the spacer openings. This set screw may be driven deeper into the body of the cassette with, for example, a screwdriver, an Allen wrench, or the tip of the handcuff key.

These and other aspects of the present invention are realized in a magnetic table as shown and described in the following figures and related description. It will be appreciated that various embodiments of the invention may not include each aspect set forth above and aspects discussed above shall not be read into the claims unless specifically described therein.

### BRIEF DESCRIPTION OF THE DRAWINGS

Various embodiments of the present disclosure are shown and described in reference to the numbered drawings.

FIG. 1 shows a top view of one embodiment of a locking cassette with two loops;

FIG. 2 shows a top view of one embodiment of a rotating locking member, including the securing edge;

FIG. 3 shows a plan view of a switchable single-loop or dual-loop embodiment of the locking cassette;

FIG. 4 shows an exploded view of a single-loop embodiment of a locking cassette, which may be tightened by pulling on the free ends of the cord, or can be unlocked with a key;

FIG. 5 shows a top view of a dual-loop embodiment in which one portion of the cord is secured in the body of the cassette, and further in which the spacer opening extends through the body of the cassette;

FIG. 6 shows a perspective view of another dual-loop embodiment in which the cord may be pulled to tighten the handcuffs, and further in which the cord is looped through spacer openings in the base member.

FIG. 7 shows a dual-loop embodiment in which the cord is pinched between the spacer openings with a set screw, such that when the screw is fully inserted, it pinches the cord and prevents one loop of the handcuff from being loosened while the other loop of the handcuff is tightened.

It will be appreciated that the drawings are illustrative and not limiting of the scope of the invention which is defined by the appended claims. The embodiments shown accomplish various aspects and objects of the invention. It will be appreciated that it is not possible to clearly show each element and aspect of the present disclosure in a single figure, and as such, multiple figures are presented to separately illustrate the various details of different aspects of the invention in greater clarity. Similarly, not all configurations or embodiments described herein or covered by the appended claims will include all of the aspects of the present disclosure as discussed above.

### DETAILED DESCRIPTION

Various aspects of the invention and accompanying drawings will now be discussed in reference to the numerals provided therein so as to enable one skilled in the art to practice the present invention. The skilled artisan will understand, however, that the methods described below can be practiced without employing these specific details, or that they can be used for purposes other than those described herein. Indeed, they can be modified and can be used in conjunction with products and techniques known to those of skill in the art in light of the present disclosure. The drawings and the descriptions thereof are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

Reference in the specification to “one configuration,” “one embodiment” “one aspect” or “a configuration,” “an embodiment” or “an aspect” means that a particular feature, structure, or characteristic described in connection with the configuration may be included in at least one configuration and not that any particular configuration is required to have a particular feature, structure or characteristic described herein. The appearances of the phrase “in one configuration” or similar phrases in various places in the specification are not necessarily all referring to the same configuration, and may not necessarily limit the inclusion of a particular element of the invention to a single configuration, rather the element may be included in other or all configurations discussed herein. Thus it will be appreciated that the claims are not intended to be limited by the representative configurations shown herein. Rather, the various representative configurations are simply provided to help one of ordinary skill in the art to practice the inventive concepts claimed herein.

Furthermore, the described features, structures, or characteristics of embodiments of the present disclosure may be combined in any suitable manner in one or more embodiments. In the following description, numerous specific details may be provided, such as examples of products or manufacturing techniques that may be used, to provide a thorough understanding of embodiments of the invention. One skilled in the relevant art will recognize, however, that embodiments discussed in the disclosure may be practiced without one or more of the specific details, or with other methods, components, materials, and so forth. In other instances, well-known structures, materials, or operations may not be shown or described in detail to avoid obscuring aspects of the invention.

Before the present invention is disclosed and described in detail, it should be understood that the present invention is not limited to any particular structures, process steps, or materials discussed or disclosed herein. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of that aspect in the claims.

It should also be noted that, as used in this specification and the appended claims, singular forms such as “a,” “an,” and “the” may include the plural unless the context clearly dictates otherwise. Thus, for example, reference to “a bracket” may include an embodiment having one or more of such brackets, and reference to “the target plate” may include reference to one or more of such target plates.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

The invention and accompanying drawings will now be discussed in reference to the numerals provided therein so as to enable one skilled in the art to practice the present invention. The drawings and descriptions are intended to be exemplary of various aspects of the invention and are not intended to narrow the scope of the appended claims. Furthermore, it will be appreciated that the drawings may show aspects of the invention in isolation and the elements in one figure may be used in conjunction with elements shown in other figures.

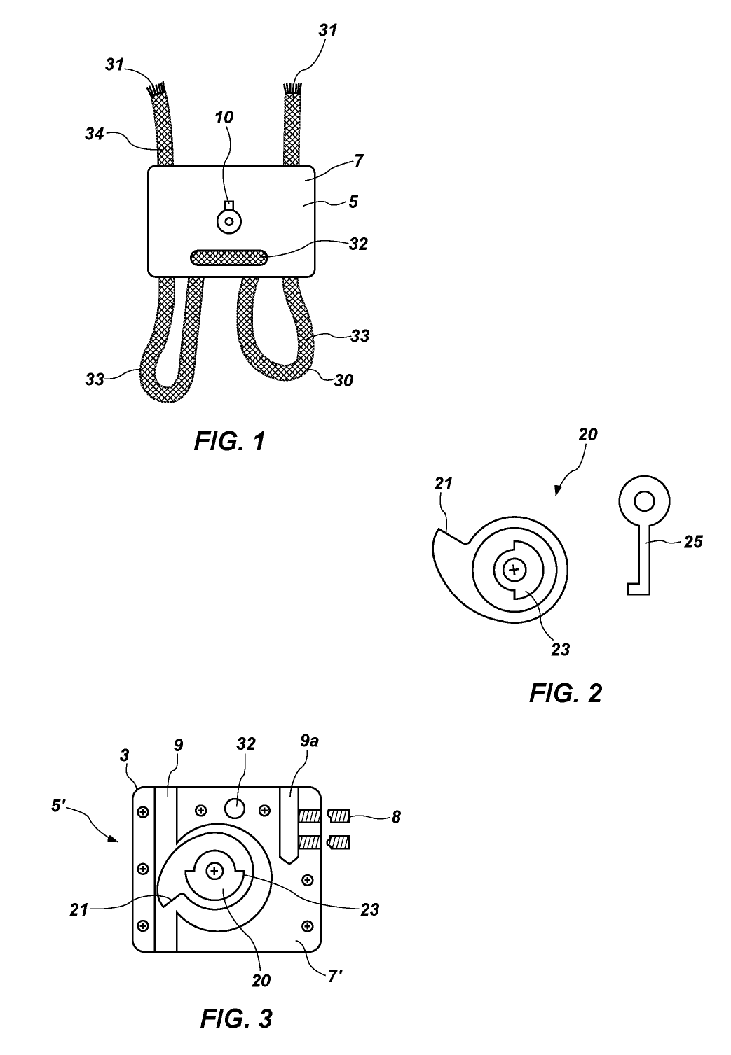

Turning now to FIG. 1, there is shown an external view of one embodiment of the locking cassette 5 which can be used to form a set of highly portable restraints. The cassette 5 has a body 7 with a plurality of channels (not shown in FIG. 1) disposed therein. Body 7 may also include a number of openings, such as opening 32 which extends through at least a part of the body. A piece of cord 30 may be disposed in the channels and through the openings in such a manner as to form loops of cord 30 to selectively restraining one or more body parts of an individual.

The body 7 may also include one or more keyhole 10. The keyhole 10 allows a key (not shown) to interact with a rotating locking member 20, shown in FIG. 2. As will be explained in additional detail below, the locking member 20 engages the cord 30 to selectively prevent the cord from being withdrawn from a channel in the body 7 of the cassette 5.

As shown in FIG. 1, the cord 30 loops through one or more spacer opening 32 to divide a portion of the cord and thereby form loops 33 which can be fit about the arms or legs of a detainee. The cord 30 continues from the loops 33, through the body 7 of the cassette and extends out of exit openings 34. Pulling on the potions of the cord 30 beyond the exit openings tightens the loops 33.When locked, the locking member(s) 20 (FIG. 2) inside the locking cassette 5 prevents the cord 30 from being loosened, but allows a user to pull on the ends of the cord 31 in order to tighten the loops to thereby tighten the handcuffs/ankle cuffs. When unlocked, the locking cassette 5 allows the cord 30 to be freely tightened or loosened.

As indicated in FIG. 1, the spacer opening 32 may be an aperture extending entirely through the body of the cassette 5. However, it will be appreciated that it is not necessary to equip the locking cassette 5 with a spacer opening 32. A spacer opening 32 is advantageous because a user can make two loops of cord 30 therewith, however, a person may be restrained adequately with just one loop securing both wrists together.

One advantage of the present disclosure is that the length of the cord 30 is essentially unlimited. The handcuff portions of the cord 30 can thus be withdrawn to any desired length, permitting the locking cassette 5 to serve as a knotless, tighten-able, tamper-resistant means of securing anything that can be secured with cord. For example, it may be advantageous to use the handcuff cassette to secure truckbed loads or luggage. In that case, a user can draw out a single very long loop of cord 30 (formed by running the cord 30 through the cassette twice,) and can then use the very long loop to lash down supplies. The handcuff cassette can then be locked as usual, securing the luggage or supplies against jolting or easy theft. Unlike conventional handcuffs, the hand cuffs can be used on a wide range of wrist sizes, from that of a very petite woman to those of a very large man.

FIG. 2 shows one embodiment of the rotating locking member, indicated generally at 20, including the securing edge 21. Those skilled in the art will appreciate that the locking member 20 is a cam which is configured to prevent the withdrawal of the cord from the channels. Thus, the locking member 20 is normally biased into a closed position wherein it forcefully engages the cord.

Also shown in FIG. 2 on the locking member is a key engagement member 23. The key engagement member 23 is a semicircular ledge around the core of the rotating locking member 20. In some embodiments, such as the one pictured, the key engagement member 23 circumscribes half (or 180 degrees) of the center of the rotating locking member 20. In other embodiments, the key engagement member surrounds about a third (or 120 degrees) of the rotating locking member. In order to allow the cord 30 (FIG. 1) to be loosened, the user engages the key engagement member 23 with the key and against the direction of engagement, loosening the engagement between the locking member 20 and the cord 30 (FIG. 1). This, in turn, allows the locking mechanism to disengage tend the cord to be withdrawn.

The configuration of the key engagement member 20 can be configured to cause the handcuffs to be more difficult to open with improvised lockpicking tools. When the key is inserted into the keyhole 10 (FIG. 1) and then turned, the key 25 engages with the key engagement member 23 and levers the rotating locking member 20 open.

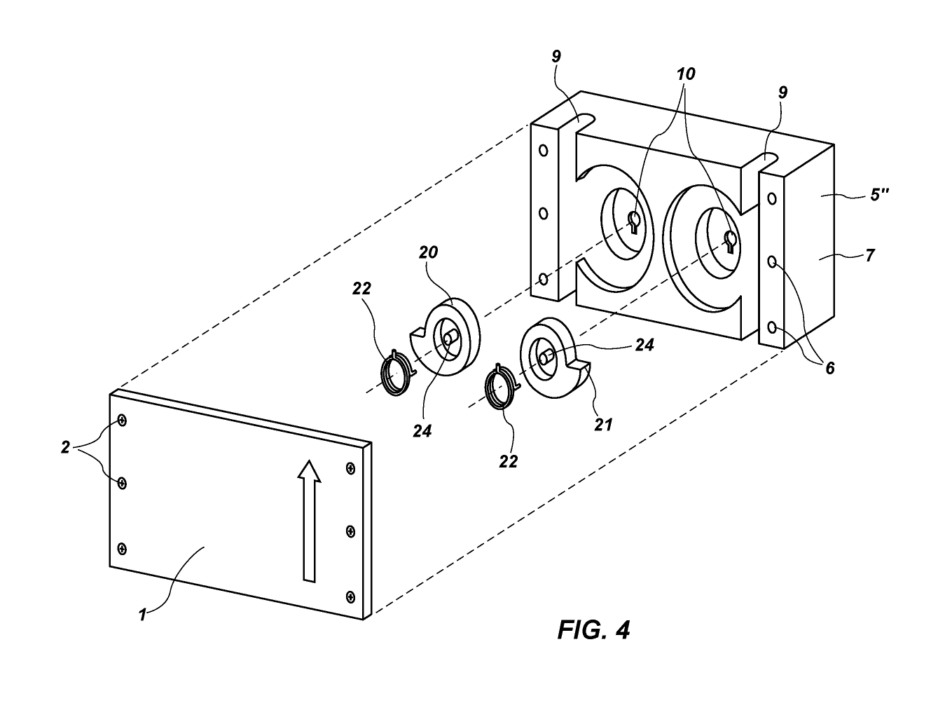

FIG. 3 shows a top plan view of the body 7′ of a switchable single-loop or dual-loop embodiment of the locking cassette, indicated generally at 5′. The locking cassette 5 may have at least one channel 9 extending through the cassette 5. The locking mechanism 20 may be disposed along the channel 9 to selectively limit advancement of a cord disposed in the channel.

The cord (not shown) may be threaded through this channel 9, formed into a partial loop, and then through spacer opening 32, formed into another partial loop, and then into terminating channel 9a, where the cord is secured with cord securing mechanism 8. The securing mechanism 8 may be a set screw, a cam, a unidirectional fastener or other configuration for holding the end of the rope When the cord is threaded as such, this configuration produces two handcuff loops. Alternately, the cord (not shown) is threaded through channel 9, and then into terminating channel 9a, where the cord is secured with cord securing mechanism 8. This configuration produces a single handcuff loop. It will also be appreciated that the cord can be set and anchored in the terminating channel 9a and then either advanced directly to the channel 9 to form a single loop restraint or passed through the opening 32 to form a double loop restraint. Because the cord can be withdrawn from the channel 9 when the locking member 20 is disengaged, the user can selectively pass it through the opening 32 for selectively form one or two loop restraints.

Also shown in FIG. 3 is the rotating locking member or pawl or cam 20, and the securing edge 21. When a key is inserted, the prongs of the key engage with the key engagement member 23, allowing a user to twist the rotating locking member 20 open. When a user releases the key, spring tension rings (not pictured, but located beneath the rotating locking member 20 in this embodiment; see FIG. 4) return the rotating locking member 20 to its locked position. When locked, the rotating locking member 20 does not freely rotate from the position shown in FIG. 3, and thus prevents the cord (not shown) from being drawn out to make the handcuffs looser. The curve of the cam, however, may allow the cord to be pulled to make the handcuffs tighter if necessary.

FIG. 4 illustrates an exploded view of a single-loop embodiment of a locking cassette 5″, which includes a body 7 having a pair of rotating locking members 20 disposed therein, each adjacent a channel 9 configured to receive cord (not shown). The rotatable locking members 20 may be operated by the insertion of a key (not shown) through the keyholes 10. When a key is inserted, the retaining peg 24 is depressed in this embodiment, releasing tension on the spring tension rings 22. It will be appreciated that any other means of releaseably locking the rotating locking members 20 in place known to one of skill in the art may likewise be used.

In this embodiment, a cover plate 1 is removeably attached with fastener 2 and 6 to the locking cassette 5″. Fasteners 2 and 6 may include, for example, screws 2 and pre-drilled screw holes 6.

FIG. 4 also illustrates a single-loop embodiment of the present invention. The cord (not shown) is threaded through the channels 9, to form a single loop for restraining both wrists, or for securing luggage or other loads. It will be appreciated that adding an opening, such as opening 32 in FIG. 3, would allow the formation of a double loop handcuff configuration.

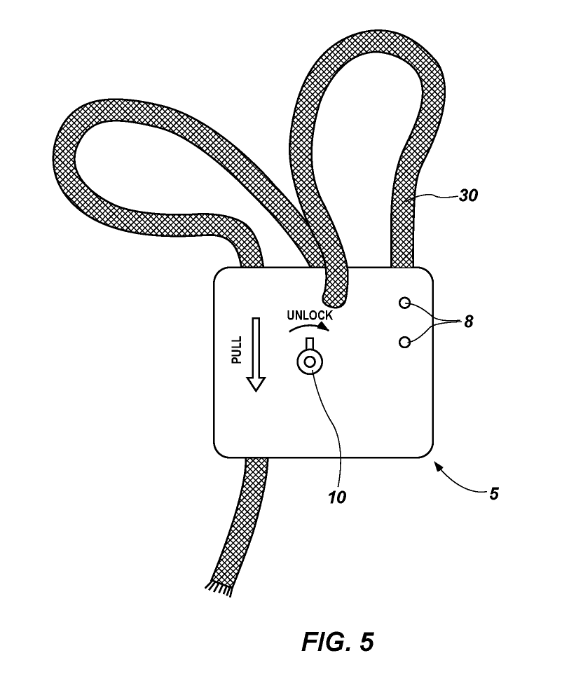

FIG. 5 shows a dual-loop embodiment of the locking cassette 5′″. One portion of the cord 30 is secured in the body of the cassette 5′″ using cord securing mechanism 8. A single keyhole 10 allows the cassette 5′″ to be locked or unlocked.

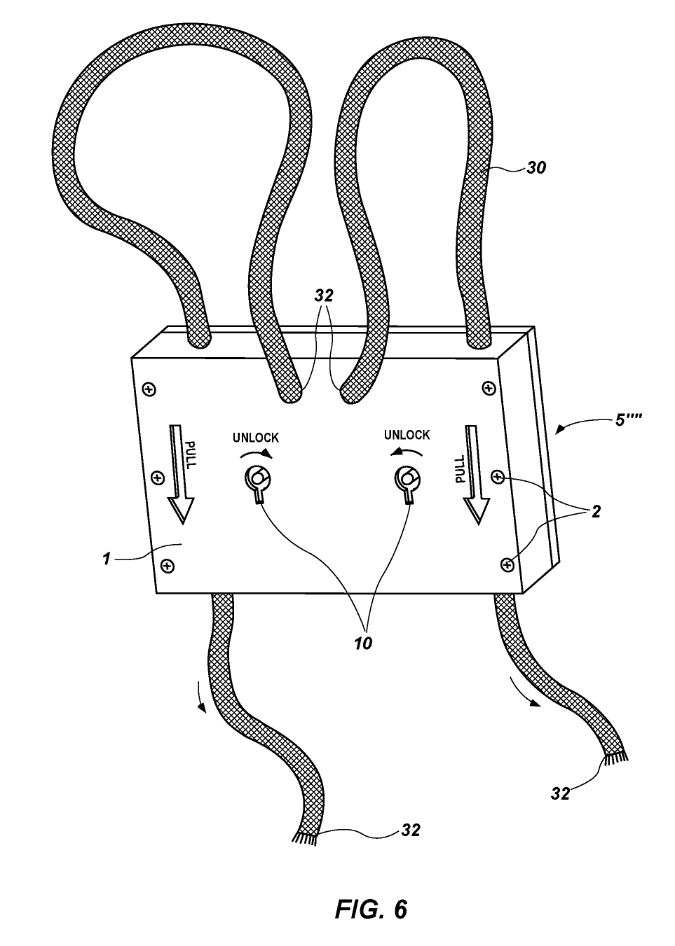

FIG. 6 shows another dual-loop embodiment of the locking cassette, indicated generally at 5″″. The body 7 may be substantially the same as that shown in FIG. 4, but with the addition of the openings 4. The present embodiment includes two key holes 10 for accepting a standard handcuff key (not shown.) Additionally, the locking cassette 5″″ includes a cover plate 1, attached via fastener 2. The cover plate 1, in this embodiment, is printed with instructions in order to make use of the locking cassette 5″″ easier during stressful situations. The cord 30 is looped through a pair of channels (not shown) and further through two spacer openings 32 to produce two handcuff loops. The ends of the cord 32 may be pulled to tighten the handcuffs at any time, but the handcuff loops may only be loosened when the cassette 5″″ is unlocked.

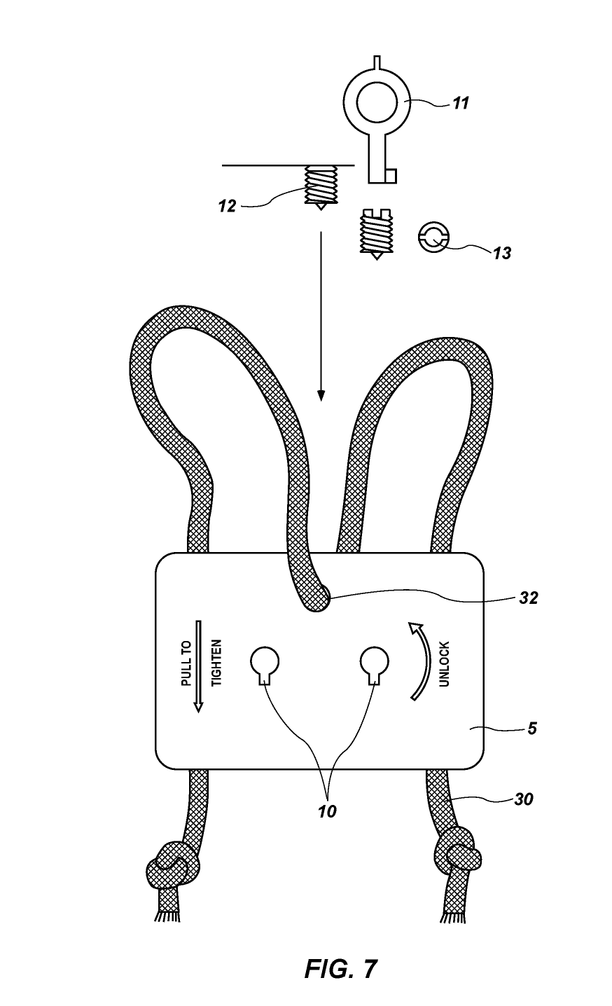

FIG. 7 shows another dual-loop embodiment of the locking cassette, indicated at 5″″. The embodiment includes two key holes 10 for accepting a standard handcuff key 11. Additionally, the locking cassette 5″″ includes a cord 30 and spacer openings 32. A set screw 12 is inserted through the top of the locking cassette 5, between the spacer openings 32. When fully inserted, the set screw 12 engages the cord 30, preventing one loop of the cassette 5″″ from being enlarged while the other loop is made smaller. The set screw 12 may have a slot 13 adapted for accepting the handcuff key 11, so that a user may employ the handcuff key 11 in order to tighten or loosen the set screw. It will be recognized that the slot 13 may instead be adapted to engage the point of a Phillips-head screwdriver, a hex wrench, a flat-head screwdriver, or any other means known to one of skill in the art for tightening a set screw.

Thus there is disclosed a locking cassette system and methods of making and using the same. It will be appreciated that numerous modifications may be made without departing from the scope and spirit of this disclosure. The appended claims are intended to cover such modifications.

What is claimed is:

1. A locking cassette restraint comprising:
A body comprising:
a cover plate and a base member;
at least one keyhole;
a rotating locking member having a keyhole therethrough, the rotating locking member having a securing edge;
and a channel for receiving a cord
wherein the channel terminates in two cord openings.

2. The locking cassette restraint of claim 1, further comprising a cord.

3. The locking cassette restraint of claim 2, in which the body comprises rounded edges.

4. The locking cassette of claim 3, further comprising a spacer opening, and wherein the cord forms at least two loops.

5. The locking cassette of claim 4, further comprising at least one tensioner.

6. The locking cassette of claim 5, in which the cover plate further comprises instructions inscribed thereupon for using the locking cassette.

7. The locking cassette of claim 5, further comprising at least one fastener for releasably attaching the cover plate and the base member.

8. The locking cassette of claim 5, wherein the base member further comprises cord at least one securing mechanism.

9. The locking cassette of claim 8, wherein the at least one securing mechanism is at least one screw.

10. The locking cassette of claim 2, wherein the cord is paracord.

11. The locking cassette of claim 7, wherein the at least one fastener comprises four or more screws.

12. The locking cassette of claim 5, wherein the tensioner comprises spring tension rings.

13. The locking cassette of claim 12, further comprising a retaining peg.

14. The locking cassette of claim 5, wherein the tensioner is a pressure bar.

15. A locking cassette restraint comprising:
A body comprising:
a cover plate and a base member;
at least one fastener for connecting the cover plate and the base member;
two rotating locking members having keyholes therethrough, each rotating locking member having a securing edge, a retaining peg, and a spring tension ring;
two spacer openings;
and a channel for receiving a cord, the channel terminating in two cord openings.

16. The locking cassette restraint of claim 15, further comprising kernmantle rope.

17. The locking cassette restraint of claim 15, further comprising instructions inscribed on the body.

18. The locking cassette restraint of claim 15, wherein the body is formed of metal, and further wherein a set screw is positioned between the spacer openings, the set screw being operable by a handcuff key.

19. A method of forming a locking cassette comprising the steps of:
forming a box having a removeably attachable cover plate;
forming channels in the box for receiving a single length of cord;
affixing a rotating locking member, having a keyhole therein, into the box; and
threading a cord through the box, such that the cord is in contact with the rotating locking member.

20. The method of claim 19, further comprising the step of fixing one end of the cord inside the box with the securing mechanism.
